(19) United States
(12) Patent Application Publication
(10) Pub. No.: US 2019/0370350 A1
(43) Pub. Date: Dec. 5, 2019

(54) Dynamic Configurability of Web Pages

(71) Applicant: BrightEdge Technologies, Inc., Foster City, CA (US)

(72) Inventors: Hyman Chung, San Ramon, CA (US); Shiny Singh, Foster City, CA (US); Samyuktha Jayaraman, Cupertino, CA (US); Hongbo MA, Sunnyvale, CA (US); Lei Zhao, San Mateo, CA (US); Sammy Yu, San Mateo, CA (US); Tianyao Zhang, San Mateo, CA (US)

(73) Assignee: BrightEdge Technologies, Inc., Foster City, CA (US)

(21) Appl. No.: 15/993,911

(22) Filed: May 31, 2018

(51) Int. Cl. G06F 17/30; G06F 8/61

(52) U.S. Cl. CPC G06F 17/3089; G06F 17/30905; G06F 17/28; G06F 17/30876; G06F 8/61; G06F 17/30902

(57) ABSTRACT

In an embodiment, a processor receives a request for a first web page within a website. In response, the processor sends over a computer network a request for a web-page modification to the first web page. The processor receives the requested web-page modification, which includes a link associated with a second web page within the website, and configured to be installed in the first web page. The processor then modifies the first web page to incorporate the web-page modification, and the modified web page is then served to the requestor.

### CROSS REFERENCE TO RELATED APPLICATION

This application is related to the application titled Dynamic Configurability of Web Pages Including Anchor Text, filed on May 31, 2018, the contents of which are incorporated herein in their entirety.

### BACKGROUND

The disclosed embodiments relate generally to the inclusion and distribution of content. In particular, the disclosed embodiments relate to systems and methods for modifying the computer code used for building and serving a web page. More specifically, this disclosure relates to modifying a web page to include a precalculated set of links within the web page in a way the increases the likelihood of boosting the ranking of the website in search engines results.

Modern internet search engines are highly dependent on how the various web pages within websites are organized and arranged, and in particular, how these web pages are linked together. The configuration of linking determines how web pages are ranked when returned as search results. One of the major factors in determining rank of the page when a user searches for a topic on the web is the number of hyperlinks on other webpages that direct to the pages being ranked. All things being equal, if two pages have the same content, but one had more hyperlinks that is directing to it from other relevant pages, the page with the more hyperlinks directing to it from other pages would be ranked ahead of the page with fewer hyperlinks. Further, an important method for how search engines discover new and updated pages to be added and indexed for different search terms is to evaluate a first page, and then move on to the next set of pages that are hyperlinked to the first page, appraising the relevancy and authority of each page as an indexing program navigates through the hyperlinks. Indexing programs typically rely on an enormous set of computers to fetch, or “crawl” the billions of pages that exist on the web. They rely on an algorithmic process to determine which sites to crawl, how often, and how many hyperlinks to follow in a particular path.

The crawl process used by a typical web-indexing program can begin with a list of webpage URLs, typically generated from previous crawls, and typically with the help of a sitemap provided by the crawled website. As the website is crawled by the indexing program, the indexing program is configured to detect links (e.g., SRC and HREF attribute and anchor tag) within the crawled page, and then adds them to its list of pages to crawl. In this way, the indexing program can account for new sites, changes to existing sites, and dead links, all of which can be used to update the index and rank pages according to the number of hyperlinks directing to it.

Because indexing programs follow links from page to page, if a website owner would like the website to achieve a high rank in a search engine for a given search (called search engine optimization, or SEO), each page-to-page link within a website should be as relevant as possible, and should map to appropriate web searches.

Search engine optimization can be described as the process of affecting the online visibility of a website or a web page in a web search engine's unpaid results—often referred to as natural, organic, or earned, results. In general, the earlier (or higher ranked on the search results page) and more frequently a website appears in the search results list, the more visitors it will receive from the search engine's users. For many websites, that kind of visibility is correlated with the ability of a website to attract new potential customers and ultimately earn money, whether from advertisements or online sales.

This is particularly true for eCommerce websites, which typically include significantly more pages than a personal website or a website that simply displays business information. For some eCommerce websites, the number of pages that make up the site can be in the millions because often those websites contain pages for categories of products and individual product listing pages.

Modifying a website to improve SEO may involve editing its HTML and associated coding to increase both the website's relevance and discoverability. Efforts to improve SEO may also entail removing barriers to the indexing and ranking activities of various search engines. As discussed above, this modification can include linking pages within a website to other pages within a website that are found to share relevant content across the pages and to provide signals of relevance and authority about a particular topic. The sheer size of such websites, however creates problems for programs, bots, crawlers, and the like, designed to map the web for searching by consumers.

A well-designed, well-architected, website will employ various schemes for SEO. A poorly-architected website, on the other hand, will suffer because it is not optimized for search-engine relevancy, and in many cases, can be penalized in ranking by violating various rules used to rank web pages (i.e., overuse of specific keyword—keyword stuffing; too many irrelevant links—link spam, lack of substance in subject matter—thin content, etc.). These problems can happen at the outset, as a website is built and launched. More often than not, however, the violations happen over time as websites are expanded to fulfill a business's changing needs because many SEO factors are not taken into account in that expansion.

One of the most important and most challenging part of any search optimization effort is the relevant internal linking of web pages within a web site. The challenges include both identifying and ranking appropriate internal links, and modifying the web page to include the links in a way that improves a web page's SEO. To truly improve SEO, when developing an appropriate network of links among the web pages of any domain, the links should account for at least some of the following issues: be contextually relevant, improve user experience, reduce bounce rate, increase engagement, possess value-adding anchor text, use diversified anchor text across pages, support both offensive and defensive SEO strategies, help optimize crawl budget, support improved placement in the search engine results page (“SERP”) rank and growth of keyword footprint, adapt to different sections on a domain, and improve revenue.

Achieving even a few of the above goals is challenging, especially at scale. Thus, a need exists for a system to quickly and efficiently edit a web page to include links to other web pages, thereby improving both user experience and search engine optimization.

### SUMMARY

Embodiments of the present invention generally relate to systems and methods for modifying the computer code used for building and serving a web page. More specifically, this disclosure relates to modifying a web page to include a precalculated set of links within the web page in a way the increases the likelihood of boosting the ranking of the website in search engines results.

In one embodiment, a method includes receiving, at a processor, a request for a first web page within a website, and sending, from the processor, a request for a modification to the first web page, the modification including at least one link associated with a second web page. The requested link is received by the processor, which then modifies the first web page by incorporating the link into the first web page and then serving the modified first web page.

In another embodiment, a method includes receiving, at a processor, a set of content and strategy data for a first page on a website, and determining a link to at least a second web page on the website, the link being relevant to both the first and second web page, and where the determining is based on, at least in part, the contents of the set of content and strategy data. The link is then configured to be included in a link block that is associated with the structure of the first web page, and that is configured to be installed in the first web page. Finally, the link block is sent over the network to be included in a served and/or displayed web page.

In another embodiment, a method comprises determining, by a processor, a set of relevant keywords for a first web page. Then the processor determines a set of links that include keywords in common with the first web page. Once the set of links is determined, and includes at least one link, it is sorted to create a subset of links found to be relevant to the first web page. Appropriate anchor text for member or members of the subset of links is determined and configured for inclusion into the first web page. Once the anchor text is configured for inclusion into the first web page, it is sent to the first web page for inclusion in the first web page.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for modifying web pages, according to an embodiment, including a website publishing system, a user terminal, a communication network, a link prepublishing system, and a content delivery network (“CDN”).

FIG. 2 is a flow chart of a process for modifying web pages by a link prepublishing system, according to an embodiment.

FIG. 3 is a flow chart of a process for modifying web pages to be served by a website publishing system.

FIG. 4 is a flow chart of a process for modifying web pages to be displayed at a user terminal, according to an embodiment.

FIG. 5 is a flow chart of a process for determining anchor text, according to an embodiment.

### DETAILED DESCRIPTION

One or more of the systems and methods described herein describe a way of modifying a first web page to include links to other web pages that are found to be relevant to the first web page. As used in this specification, the singular forms “a” “an” and “the include plural referents unless the context clearly dictates otherwise. Thus, for example, the term “a computer server” or “server” is intended to mean a single computer server or a combination of computer servers. Likewise, “a processor” is intended to mean one or more processors, or a combination thereof.

One skilled in the art will understand that a web page is a document on the Internet, and that a website comprises one or more web pages that are linked together.

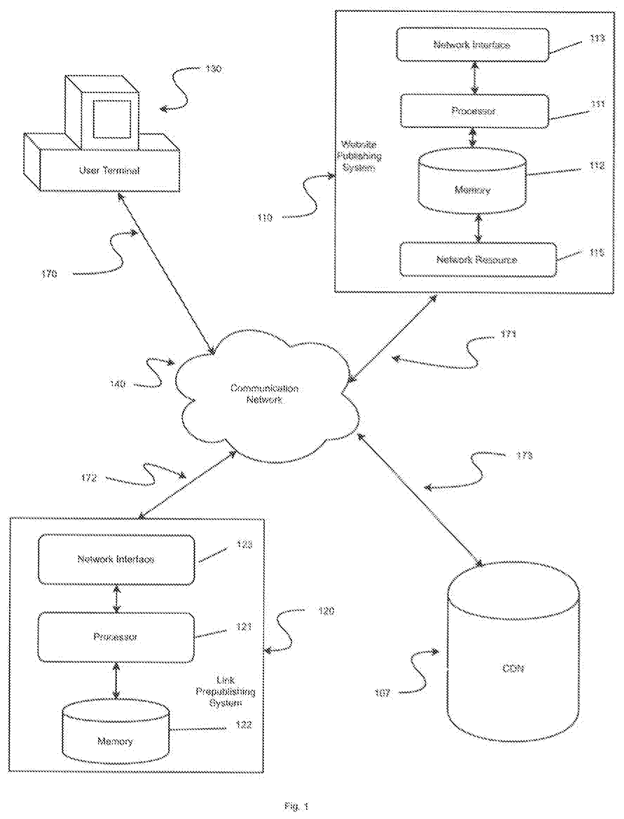

FIG. 1 is a block diagram of a system for modifying a first web page to include a link or URL referring to a second web page (or a plurality of links or URLs, each referring to a web page), and serving or displaying the modified first web. The first web page is modified to include links intended to improve SEO, improve user experience, and minimize impact on any lag experienced by an end user when requesting the first page.

As illustrated in FIG. 1, in an embodiment, user terminal 130 sends through communication network 140, via network connection 170, a request for a web page. Website publishing system 110 receives the request via network connection 171, but instead of simply serving the web page, in an embodiment, website publishing system 110 communicates either directly or indirectly with link prepublishing system 120 through communication network 140 and network connections 171 and 172, and requests a set of links that have been determined by link prepublishing system 120 to meet predetermined relevance criteria. The term website publishing system as used in this document is a computer-based system connected to a network, and includes the functionality of both receiving a request for a first web page and serving the first web page.

The set of links, as described in this document, includes at least one link (or in an embodiment, a plurality of links) that, when clicked on, will access a second web page (or other web pages, respectively). In an embodiment, the set of links, when included in the first web page, will improve SEO for that web page. For the purposes of this document, the term link, also known as a hyperlink, is used to mean a reference to data that a website user can directly follow either by clicking, tapping, or hovering; acting on the link in such a way (or a similar way) that allows for navigation directly to a target URL. A link points to an entire document or to a specific element within a document.

Network connections 170, 171, and 172 can be any appropriate network connection for operatively coupling user terminal 130, web server system 110, and link prepublishing system 120 to communication network 140.

In one embodiment, in response to the request received from website publishing system 110, link prepublishing system 120 sends the set of links back through communication network 140 to be received by website publishing system 110. In an embodiment, the set of links are encapsulated in a link block that is configured to be incorporated into the first web page. Once website publishing system 110 receives the rule library, the requested web page can be modified based on the received set of links, and then served to user terminal 130. In an embodiment, the requested web page is modified by changing the computer code on which the requested web page is based.

Communication network 140 can be any communications network configurable to allow website publishing system 110, user terminal 130, and link prepublishing system 120, to communicate with communication network 140 and/or to each other through communication network 140. Communication network 140 can be any network or combination of networks capable of transmitting information (e.g., data and/or signals) and include, for example, a telephone network, an Ethernet network, a fiber-optic network, a wireless network, and/or a cellular network. In some embodiments, communication network 140 can include multiple networks operatively coupled one to another by, for example, network bridges, routers, switches and/or gateways. For example, user terminal 130 can be operatively coupled to a cellular network, link prepublishing system 120 can be operatively coupled to an Ethernet network, and website publishing system 110 can be operatively coupled to a fiber-optic network. The cellular network, Ethernet network and fiber optic network can each be operatively coupled one to another via one or more network bridges, routers, switches and/or gateways such that the cellular network, the Ethernet network and the fiber-optic network are operatively coupled to form a communication network. Alternatively, for example, the cellular network, the Ethernet network, and the fiber-optic net work can each be operatively coupled to the Internet such that the cellular network, the Ethernet network, the fiber-optic network and the Internet are operatively coupled to form a communication network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL) connection, a broadband coaxial connection, and/or a fiber-optic connection. In some embodiments, a user terminal, partner application and/or website publishing system can be operatively coupled to a communication network by heterogeneous network connections. For example, a user terminal can be operatively coupled to the communication network by a WWAN network connection, a partner application can be operatively coupled to the communication network by a DSL network connection, and a website publishing system can be operatively coupled to the communication network by a fiber optic network connection.

In an embodiment, once a web page is modified by website publishing system 110, the modified web page is cached in content delivery network (“CDN”) 107. For the purposes of embodiments of the invention, CDN 107 can be a CDN owned or controlled by website publishing system 110, or can be a third-party CDN, or can be any known commercial CDN, or can be a CDN associated with link prepublishing system 120, or any combination of possible CDNs.

In an embodiment, link prepublishing system 120 can create a set of links by receiving a set of content and strategy data from website publishing system 110, via network interface 123, storing the received data in memory 122, and processing the set of content and strategy data at processor 121 to create an appropriate set of links to be included in the first website. In an embodiment, content and strategy data can include a web page's meta data, which can include, for example (but not limited to) the web page's URL, keywords gathered from search engines about the web page, and the search volume of those keywords. In an embodiment, the most common search queries are identified for all (or a defined subset) of pages within a website that bring traffic to those pages. When two (or more) pages rank above a predefined threshold, the content within those pages are deemed relevant to the other pages in the website (or defined subset).

In an embodiment, content and strategy data can include visitor behavior analytics. For example, when a user navigates to a first web page, the most common next and subsequent web pages to which users navigate can be identified as relevant to the first web page. In an embodiment, web pages to which a user navigates prior to navigating to the first web page can be identified as relevant.

In an embodiment, content and strategy data can include natural language processing such that known natural language processing algorithms are used to scan the content of pages to understand the subject matter, and to create a list of keywords that the page is about. In an embodiment, content and strategy data can include the content within the page itself, which can include, for example (but not limited to), the title of the web page, the summary description, and the body content.

Alternatively, link prepublishing system 120 can create a set of links based on content and strategy data that has been determined within link prepublishing system 120 on processor 121. Once the set of links is created, it can be stored in memory 122 for access by website publishing system when the relevant web page is requested, or to be sent to website publishing system at a predetermined time. Network interface 121 can be any network interface configurable to be operatively coupled to communication network 140 via network connection 172. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

In one embodiment, website publishing system 110 sends a request for a set of links through communication network 140 to CDN 107. Upon receiving the request, CDN 107 sends the set of links to website publishing system 110 via communication network 140 to create a modified the first web page by incorporating the set of links, or a subset of the links, into the first web page, prior to serving the modified first web page to user terminal 130.

In an embodiment, the website publishing system can be based in any combination of hardware and software. In an embodiment, website publishing system 110 includes network interface 113, processor 111, memory 112, and network resource 115. Website publishing system 110 is operatively coupled to communication network 140 via network interface 113 and network connection 171. Network interface 113 can be any network interface configurable to be operatively coupled to communication network 140 via network connection 171. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

Processor 111 is operatively coupled to network interface 113 such that processor 111 can be configured to be in communication with communication network 140 via network interface 113. In an embodiment, processor 111 (and processor 121) can be any of a variety and combination of processors, and can be distributed among various types and pieces of hardware, or even across a network. Such processors can be implemented, for example, as hardware modules such as embedded microprocessors, microprocessors as part of a computer system, Application Specific Integrated Circuits (ASICs'), and Programmable Logic Devices (“PLDs). Some such processors can have multiple instruction executing units or cores. Such processors can also be implemented as one or more software modules in programming languages as Java™, C++, C, assembly, a hardware description language, or any other Suitable programming language. A processor according to some embodiments includes media and computer code (also can be referred to as code) specially designed and constructed for the specific purpose or purposes.

Processor 111 is also operatively coupled to memory 112 which, in an embodiment, can be used to store web pages, a set of content and strategy data, and/or web-page modifications. In an embodiment, memory 112 (and memory 122) can be a read-only memory (“ROM”); a random-access memory (RAM) such as, for example, a magnetic disk drive, and/or solid-state RAM such as static RAM (“SRAM) or dynamic RAM (“DRAM), and/or FLASH memory or a solid-data disk (“SSD), or a magnetic, or any know type of memory. In some embodiments, a memory can be a combination of memories. For example, a memory can include a DRAM cache coupled to a magnetic disk drive and an SSD.

In addition to memories 112 and 122, some embodiments include another processor-readable medium (not shown in FIG. 1) having instructions or computer code thereon for performing various processor-implemented operations. Examples of processor-readable media include, but are not limited to: magnetic storage media Such as hard disks, floppy disks, and magnetic tape; optical storage media Such as Compact Disc/Digital Video Discs (“CD/DVDs), Compact Disc-Read Only Memories (“CD-ROMs), and holographic devices: magneto-optical storage media such as floptical disks; Solid state memory such as SSDs and FLASH memory; and ROM and RAM devices. Examples of computer code include, but are not limited to, micro-code or micro-instructions, machine instructions (such as produced by a compiler), and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

In some embodiments, a website publishing system can be a virtual device implemented in Software such as, for example, a virtual machine executing on or in a processor. For example, a website publishing system can be a software module executing in a virtual machine environment such as, for example, a Java™ module executing in a Java™ Virtual Machine (“JVM), or an operating system executing in a VMware™ virtual machine. In some Such embodiments, a network interface, a processor, and a memory can be virtualized and implemented in Software executing in, or as part of, a virtual machine.

As illustrated in FIG. 1, website publishing system 110 includes network resource 115. Network resource 115 can be, for example, a web server and/or database accessible over communication network 140. Network resource 115 can, for example, send a web page or other data formatted in hypertext markup language (“HTML”) or other languages to user terminal 130, which user terminal 130 can display to a user.

In some embodiments, a network resource can include a database configured to process database queries received by a website publishing system over a communication network. In some embodiments, a network resource can exchange encoded binary data, such as images, videos, and/or documents, for example, with a user terminal over a communication network.

Similar to website publishing system 110, in an embodiment, link prepublishing system 120 can include processor 121, memory 122, and network resource 123, and is operatively coupled to communication network 140 through network connection 172.

Similar to website publishing system 110, but not shown in FIG. 1, user terminal 130 includes a network interface, a processor and a memory, and is operatively couple to communication network 140 through network connection 170. In some embodiments, a partner application can include one or more software modules as part of a computer server operatively coupled to a communication network.

In an embodiment, link prepublishing system 120 can include, for example, a web server and/or database accessible over communication network 140, and is configured to, for example, send a web page or other data formatted in hypertext markup language (“HTML”) or other languages to user terminal 170, or to another element in communication with communication network 140, such as website publishing system 110 for inclusion into the first web page, CDN 107 for caching, and/or user terminal 130 for displaying to a user.

In some embodiments, a network resource can include a database configured to process database queries received by a website publishing system over a communication network. In some embodiments, a network resource can exchange encoded binary data, such as images, videos, and/or documents, for example, with a user terminal over a communication network.

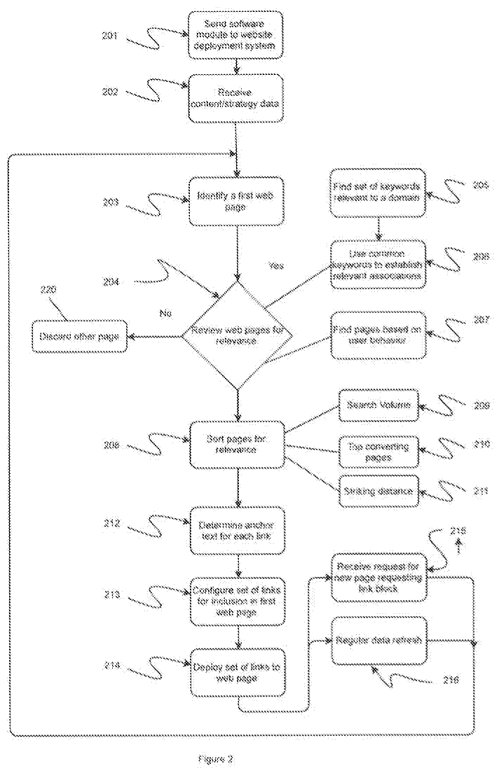

FIG. 2 is a flow chart of a process for modifying a first web page to be served by a website publishing system, according to an embodiment. A software module is sent from a link prepublishing system to a website publishing system, at 201. The software module can be an SDK, or some other computer program configured, when installed, to analyze a web page or group of web pages, and to send and receive data related to web page or pages, over a network, to and from a SaaS service, or other Internet-related service, including a link publishing system. In an embodiment, the data sent to the link publishing system includes a set of content and strategy data, at 202. In an embodiment, the content and strategy data include a set of parameters that can be used to determine an appropriate set of links for inclusion into the first web page, the set of links referring to at least a second web page.

For the purposes of the present invention, the term computer program includes software, firmware, middleware, and any code in any computer language in any configuration, including any set of instructions or data intended for, and ultimately understandable by, a computing device.

At 203, a first web page is identified. In an embodiment, the first web page is identified by receiving web page data from a web server system. In another embodiment, the first web page is identified by receiving web page data from a user terminal. In another embodiment, the first web page is identified by receiving a request to update the first web page. In yet another embodiment, the first web page is identified by the link prepublishing system according to predetermined criteria.

A predefined group of web pages, including at least a second web page, are analyzed in 204, and determined to be either relevant or not relevant to the first web page. The analysis at 204 can be performed in one or more of a number of known ways. In an embodiment, the analysis at 204 can include a keyword analysis that begins with determining a set of keywords relevant to the domain, at 205. In an embodiment, the relevant keywords include keywords used to search for the first web page and the second web page, the keywords to ultimately provide navigation to a web page. In an embodiment, relevant keywords can be determined by an organic performance analysis, and can include an analysis of which keywords are typically used to find a web page. In an embodiment, the keywords, once found, are ranked for relevance. In an embodiment, the relevant keywords for multiple web pages are found using a term-frequency/inverse-document-frequency analysis.

Once the relevant keywords for the domain are determined at 205, keywords that are common among the web pages within the domain are analyzed to determine the relevant associations among the web pages, at 206. In an embodiment, the set of keywords found in 205 may not be limited to a single domain. Rather, the keywords and the relevant associations among pages can be analyzed and determined among pages from different domains.

In an embodiment, the analysis performed in 203 can be an analysis based on user behavior, at 207. In an embodiment, user behavior analysis includes analyzing the most common pages users navigate to or from the first web page. If a web page is determined to not be relevant, it is removed from further review at 220.

Once a set of relevant web pages is established, they are sorted for relevance at 208. Relevance sorting at 208 can be performed by analyzing a number of factors, either individually or in combination. In an embodiment, relevance sorting can be based on analyzing search volume, at 209, reviewing which keywords a page in the set of relevant web pages return ranks for. In an embodiment, relevance sorting can be performed by analyzing the search volume of the determined keywords.

In an embodiment, the set of web pages is sorted by analyzing the top converting page, at 210. For example, conversion goals can be tracked by reviewing how often a page results in a goal defined by a customer. The goal can include, as examples only, whether a demonstration has been requested from the web page.

In an embodiment, the set of web pages is sorted by analyzing the striking distance from the first (or other predetermined) position in search results for a given search query, 211. For the purposes of the present invention, the term striking distance means, for a given search query, a predetermined, and sufficiently close, distance a search result is from the first (or other predetermined) position or first set of ranked results for a given search.

Each web page in the set of relevant web pages can be referred to by the URL that points to each of the web pages in the set of web pages. At 212, the anchor text for each of the URLs in the set is determined. In an embodiment, anchor text can be any combination of at least a port of the headline (<h1> tag) for the target second page, the page title (<title> tag) for the second page, the social title (og:title) for the second page, the meta description for the second page, the social description (og:description) for the second page, the keyword or keywords that the second page ranks for, and the keyword or keywords that natural language processing algorithms identify as the topic keyworks for the page. Once the anchor text for each URL in the set of web pages is determined, the information is configured in 213 to be sent to the website publishing system for incorporation into the website. For example, the set of web pages, including the anchor text information and/or their respective URLs can be packaged into a link block for sending to the website publishing system. For the purposes of this invention, a link block is HTML code that is configured to render on the webpage as a block of hyperlinks and associated anchor text in a way that appears to visitors as if it is part of the page it is embedded into. The link block, in turn, can be configured to satisfy any conditions found in a set of content and strategy data received in 202. In an embodiment, the link block is structured to fit into a module displayed on the first web page. At 214, the set of links are deployed or sent to the website publishing system for serving, or for caching to be served at a later time, possibly upon request from a user terminal. In an embodiment, the link block is preconfigured as a template. In an embodiment, the computer code underlying the link block can be customizable using HTML, CSS, JS Markup, or other types of computer code. In another embodiment, the link block data can be delivered server-side in JSON format.

In an embodiment, the link prepublishing system can update the set of links on a schedule appropriate to the domain for which content is to be published. To do this the link prepublishing system can use any combination of a destination URL manifest, data sources (including, but not limited to, a search-engine-results page, the content of the web pages themselves, web page or website analytics on how visitors navigate through the web pages) design templates, and algorithms, to generate the desired, page-specific link blocks or modules. In an embodiment, the link blocks or modules are then stored and made available to the web-server system or to a user terminal, or other requester. In an embodiment, a request for a link block is made via an API. In an embodiment, the API is accessed via a CDN that caches the data.

The process shown in 203 through 214 can be performed at an arbitrary time, or can be performed as part of a regular data refresh. Since web pages are not completely static, the relevance of keywords, or of other web pages to the first web page, may change over time. Thus, the data can be refreshed at 216, rerunning at least a portion of the process found in FIG. 2. Links can be updated periodically, such as monthly, or at arbitrary times. Alternatively, the process can begin with, or be rerun with, a prompt from the website publishing system, such that a request for a link block for a new page is received at 215.

In an embodiment, a request for a link block can use https, and can be made from the software module to an API that allows the link prepublishing system to receive the request. In an embodiment, the software module is an SDK.

In an embodiment, a link profile may be created for different sections, types, or groups of web pages within a website, allowing for the creation of a set of links for each profile. Profiles may include URL whitelisting, blacklisting and a variety of other controls to ensure that the algorithmically selected links properly support the SEO strategy and desired user experience of the pages in which links are placed.

In an embodiment, such link profiles may be grouped and prioritized to help ensure that available link placement slots on any given web page do not go to waste. For example, if the top-priority profile only generates 60% of the desired links, the system will call on the next-priority profile to fill the remaining slots.

For the purposes of the present invention, 201 and 202 are shown at the top of the method in FIG. 2 for convenience only. In practice, 201 and 202 can occur at arbitrary times, based on, for example, whether the software module sent in 201 requires an update or upgrade, or whether the content and/or strategy contained in the set of content and strategy data has changed.

In an embodiment, the set of content and strategy data is input from a user at the website publishing system. In an embodiment, the set of content and strategy data is determined at least in part by the link prepublishing system based on predetermined factors.

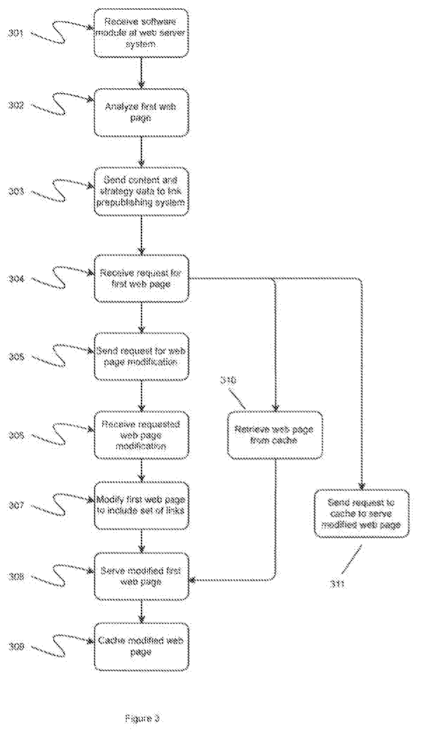

FIG. 3 is a flow chart of a process for modifying a first web page to include a relevant links to other web pages, from the perspective of a web server system. A software module is received at a web server system, at 301. The software module is sent from, for example, a link prepublishing system. The software module can be an SDK, or some other computer program configured, when installed, to analyze a web page or group of web pages, and to send and receive data related to web page or pages, over a network, to and from a SaaS service, or other Internet-related service, including a link prepublishing system.

A first web page is analyzed, at 302. In an embodiment, the first web page is analyzed by a computer program that can be located at the web server system. The analysis can include an analysis of SEO issues related to the web page, such as keywords, links, related pages, the rank (or ranks) of the relevant web pages for the keyword, the search volume of the keyword, page elements such as (but not limited to) headlines, meta descriptions, and body content. In an embodiment, the first web page is analyzed by a computer program located across a communication network. In such an embodiment, the computer program can be a SaaS service, or other online service, that is configured to crawl or otherwise review the first web page to determine SEO-related issues. In an embodiment, the first web page is analyzed by a combination of network services along with a local computer program.

Content strategy data is sent to the link prepublishing system at 303. In an embodiment, content strategy data can be calculated and determined based on the analysis of the first web page, at 302. In an embodiment, set of content and strategy data can be manually input by a user, including a user of the web server system, or a user external to the web server system. In an embodiment, sending the set of content and strategy data at 303 is not sent from a web server system; rather, the set of content and strategy data is determined by the link prepublishing system.

At 304, the web server system receives a request for a first web page. In an embodiment, the request is generated by a user terminal. In another embodiment, the request is generated by a web-based service. In an embodiment, once the request for the first web page is received, the web server system sends a request for a web page modification, at 305. In an embodiment, the requested web page modification includes a set of links configured to be installed in the first web page to create a modified web page. At 306, the requested set of links is received. In an embodiment, the received set of links are encapsulated in a module configured to be installed into the first web page. In an embodiment, the set of links are included in computer code that, when installed, modifies the first web page to include anchor text that refers to web pages found by accessing the link.

The first web page is modified at 307. In an embodiment, the modification includes installing at least one link in the set of links received at 306, creating a modified web page. Once the first web page is modified, it is served at 308. In an embodiment, the web page is modified concurrent with being served. In an embodiment, the web page is served to the party that requested the web page.

At 309, the modified web page is cached. In an embodiment, the modified web page is cached at a CDN. In an embodiment, when the request for the first web page is received at 304, the modified web page is retrieved from the cache, at 310, and then served at 308. In an embodiment, the web server system sends a request to the cache to serve the modified web page, at 311.

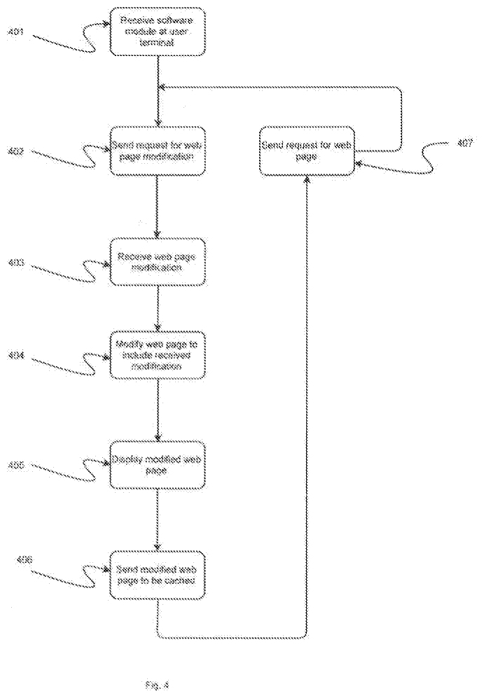

FIG. 4 is a flowchart of a process for modifying a web page for display on a user terminal. A software module is received at a user terminal, at 401. The software module is sent from, for example, a link prepublishing system. The software module can be an SDK, or some other computer program configured, when installed, to analyze a web page or group of web pages, and to send and receive data related to web page or pages, over a network, to and from a SaaS service, or other Internet-related service, including a link prepublishing system.

A request for a web page modification is sent at 402. In an embodiment, the request is sent to a link prepublishing system. At 403, the web page modification is received. In an embodiment, the received web page modification includes a set of links configured to be installed in a web page that a user desires to display on the user terminal. In an embodiment, the set of links is configured to be installed into the web page to create a modified web page. In an embodiment, the received set of links are encapsulated in a link frame configured to be installed into the first web page. In an embodiment, the set of links are included in computer code that, when installed, modifies the first web page to include anchor text that refers to web pages found by accessing the link.

The web page is modified using the received set of links, at 404. In an embodiment, the modification includes installing at least one link in the set of links received at 403, creating a modified web page. Once the first web page is modified, it is displayed at 405. In an embodiment, the web page is modified concurrent with being served. In an embodiment, the web page is served to the party that requested the web page. Once the web page is modified, the modified web page can then be sent to a cache. In an embodiment, at 406, the web page is sent directly to a cache such as, for example, a CDN. In an embodiment, the web page is sent indirectly to a cache, through, for example a web server system.

In an embodiment, a request is sent for a web page, at 407. In an embodiment, the request for the web page sent at 407 causes the user terminal to send the request for the web page modification.

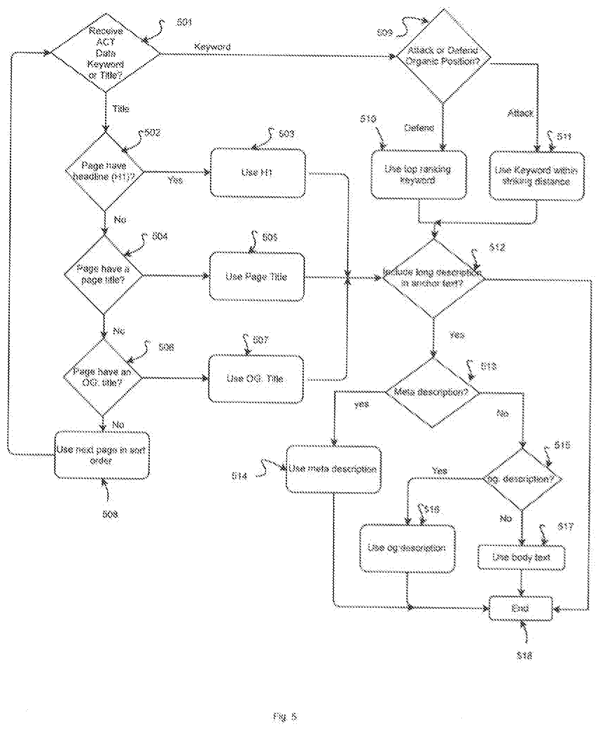

FIG. 5 is a flow chart of a process for determining anchor text, according to an embodiment. In an embodiment, at 501, anchor text configuration (ATC) data is received at a processor, and includes data for configuring the anchor text that links a first web page to a second, or target, web page. In an embodiment, anchor text configuration data can include data about a web page's SEO strategy, or about SEO preferences, or both, when determining which anchor text to deploy in the first web page. The data and preferences can include, for example, a choice of which factors, and in what order, to base the anchor text on, and can include at least some of the following factors: a preference to use either a title (or a portion of the title) of the second web page or a keyword or keywords associated with the second page, an <h1> tag, a <title> tag, an og:title, a long description, a meta description, an og:description, body text, an og:title, a long description, a meta description, an og:description, and SEO-improving variables such as user sessions, page views, conversions, ranked keywords, and any variable used by indexing programs.

For the purposes of the present invention, a long description can include a description, meta description, an og:description, or a string (or portion of a string) of characters from the body text of the second page. For the purposes of the present invention, a meta description includes a tag that is included in an html page that summarizes at least a portion of the contents of the page.

If a second web page's title is preferred over a keyword at 501, the processor then searches the code underlying the second web page to determine whether the second web page includes certain predetermined tags and metatags that can be used as anchor text. In an embodiment, at 502, the processor searches the code underlying the second web page to determine whether the second web page includes a header, or <h1>, tag. If yes, then at 503, the contents of the <h1> tag is used as anchor text. If no, at 504, the processor determines whether the second web page has a page title tag <title>. If the processor determines that the code underlying the second web page includes a <title> tag, then at 505, the contents of the <title> tag is used as anchor text. If not, at 506, the processor determines whether the second web page has an og:title metatag. If yes, then at 507, the contents of the og:title metatag is used as anchor text.

The order of determinations, above, beginning with the <h1> tag, then proceeding to the <title> tag, and then on to the og:title, are given by way of example only. In an embodiment, the order of determination of any chosen tag or meta tag can be changed, depending on a determination of the second web page's SEO needs. In other words, by way of example, in an embodiment, the processor can first determine whether the second web page includes a <title> tag, and if not, the processor can then determine if the second web page includes an <h1> tag.

In an embodiment, at 512, the processor analyzes the anchor text configuration data to determine whether to use all or a portion of a long description as anchor text. If using a long description is not preferred, then in an embodiment, at 518, the processor can insert the anchor text into a link block for a first web page to be used as a link to the second web page. If, however, the processor understands that using a long description is preferred, then at 513 the processor reviews the computer code for the second web page to see if the code includes a meta description. In an embodiment, if the processor determines that a meta description exists, then at 514, the meta description is used as anchor text. If the processor determines that no meta description exists, then in an embodiment, at 515, the processor determines whether the second web page has an og:description. If the second web page is found to have an og:description, then in an embodiment, the og:description is used as anchor text. If no og:description is found, the processor, at 518, configures body text into the link block for insertion into the first web page.

The order of determinations, above, beginning with the meta description, and then proceeding to the og:description, is given by way of example only. In an embodiment, the order of determination of any chosen tag or meta tag can be changed, depending on a determination of the second web page's SEO needs. In other words, by way of example, in an embodiment, the processor can first determine whether the second web page includes an og:description, and if not, the processor can then determine if the second web page includes a meta description.

In an embodiment, combinations of different tags and meta tags can be used to create anchor text. For example, the processor can determine if the second web page has both a <title> tag and an og:title, and use both, or portions of both, in creating anchor text. In another example, the processor can determine if the second web page has both a meta description and an og:description, and use both, or portions of both, in creating anchor text.

In an embodiment, at 501, if a second web page's keyword is preferred over a title at 501, then at 509, the processor determines preference as to whether to use create anchor text in a way the attacks or defends their organic position on a search-results page. In an embodiment, the preference to attack or defend is received in the ATC. In an embodiment, the data is received from a web page owner. In another embodiment, the data is received from a web server system. In another embodiment, the data is received from a system that calculates preferences based on predetermined parameters.

For the purposes of the present invention, attacking an organic position means employing a strategy that improves a web page's SEO by, for example, improving the web page's position on a search-results page. For the purposes of the present invention, defending an organic position means employing a strategy that maintains a web page's SEO by, for example, maintaining the web page's position on a search results page.

In an embodiment, if, at 509, the data shows a preference to attack the web page's organic position, then at 510, a top-ranking keyword is used as anchor text. One skilled in the art will appreciate that any known and practicable way of determining a top-raking keyword will be appropriate.

In an embodiment, if, at 509, the data shows a preference to defend the web page's organic position, then at 511, a keyword within a certain predefined striking distance is used as anchor text. In an embodiment, the striking distance is predefined by the ATC.

In an embodiment, once the determination to use a top ranking keyword or a keyword within striking distance is made, a determination is then made whether to use a long description as anchor text.

In some embodiments, the processes in FIGS. 2-5, or any portion or combination thereof, can be implemented as software modules. In other embodiments, the processes in FIGS. 2-5, or any portion or combination thereof, can be implemented as hardware modules. In yet other embodiments, FIGS. 2-5, or any portion or combination thereof, can be implemented as a combination of hardware modules, software modules, firmware modules, or any form of computer code.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

We claim:

1. A method, comprising:
receiving, by a processor, a request for a first web page within a website;
sending, from the processor, over a computer network, a request for a web-page modification, the web-page modification including a link associated with a second web page within the website;
receiving, by the processor, the requested web-page modification; the web-page modification configured to be installed in the first web page;
modifying, by the processor, the first web page, to incorporate the web-page modification; and
serving the modified first web page.

2. The method of claim 1, further comprising:
receiving a software module, the software module configured, when installed, to send a request for the web-page modification.

3. The method of claim 1, wherein the web-page modification is received in a link block, and wherein said modifying the first web page includes modifying the computer code of the first web page to display the link block in a predetermined location within the first web page.

4. The method of claim 1, further comprising:
sending, from the processor, a set of content and strategy data;
wherein the link received is associated with the set of content and strategy data.

5. The method of claim 1, further comprising:
caching the modified web page.

6. A method, comprising:
receiving, at a processor, a set of content and strategy data for a first page on a website;
determining, at the processor, a link to at least a second web page on the website, the link being relevant to both the first and second web page, and said determining being based on, at least in part, the set of content and strategy data;
configuring the link, at the processor, to be included in a link block, the link block being associated with the structure of the first web page;
sending the link block over a network, the link block configured to be installed in the first web page.

7. The method of claim 6, wherein said determining a relevant link is based on at least one of a common-keyword analysis, a visitor-behavior analysis, and natural language processing.

8. The method of claim 6, wherein said determining a relevant link includes determining a relevant link to each of a plurality of web pages; and further comprising:
sorting the plurality of links for relevance.

9. The method of claim 6, wherein said sorting the plurality of links is performed by at least one of sorting based on search volume of each of the plurality of links, sorting based on top-converting pages, and sorting based on striking distance.

10. The method of claim 6, further comprising:
determining a string of anchor text for the link; and
configuring the anchor text to be included in the link block.

11. The method of claim 6, further comprising:
receiving, at the processor, a request for the link block.

12. The method of claim 11, wherein the request is received over a communication network from a web-server system.

13. The method of claim 11, wherein the request is received over a communication network from a user terminal.

14. The method of claim 6, further comprising:
sending a software module, the software module including code that, when installed, is capable of performing at least one of analyzing a web page for the set of content and strategy data, sending a request to the processor for the link block, and modifying the first web page to include link block.

15. The method of claim 14, wherein the software module is configured to be installed into a web-server system.

16. The method of claim 14, wherein the software module is configured to be installed into an end-user web browser.

17. A method, comprising:
determining, by a processor, a set of relevant keywords for a first web page;
determining, by the processor, a set of links that include keywords in common with the first web page, the set of links containing at least one link;
sorting, by the processor, the set of links to create a subset of links that are relevant to search engine optimization, the subset of links containing at least one link;
receiving, by the processor, an anchor text for the at least one link within the subset of links;
configuring, by the processor, the anchor text for inclusion into a first web page;
sending, by the processor, the configured anchor text to the first web page.

18. The method of claim 17, wherein said configuring a subset of links includes including the subset of links into a software module based on the architecture of the first web page.

19. The method of claim 17, further comprising:
receiving a request for the subset of links; and wherein said sending the configured subset of links is performed in response to the received request.

20. The method of claim 18, further comprising:
determining a string of anchor text for the at least one link; and
configuring the anchor text to be included in the software module.
